(19) United States
(12) Patent Application Publication
(10) Pub. No.: US 2015/0281109 A1
(43) Pub. Date: Oct. 1, 2015

(54) SYSTEM FOR EN-QUEUING AND DE-QUEUING DATA PACKETS IN COMMUNICATION NETWORK

(71) Applicants: Sachin Saxena, Ghaziabad (IN); Ravi Kumar Malhotra, New Delhi (IN)

(72) Inventors: Sachin Saxena, Ghaziabad (IN); Ravi Kumar Malhotra, New Delhi (IN)

(21) Appl. No.: 14/229,979

(22) Filed: Mar. 30, 2014

(51) Int. Cl. H04L 12/865; H04L 12/879

(52) U.S. Cl. CPC H04L 47/6275; H04L 49/901

(57) ABSTRACT

A system for transmitting data packets includes a memory that stores buffer descriptor (BD) rings, packet en-queuing and de-queuing modules, and a network controller. The packet en-queuing module en-queues a first data packet into a first BD ring based on a first priority value of the first data packet and a first set of quality-of-service (QoS) rules. The packet de-queuing module de-queues a second data packet from a second BD ring based on a second set of quality-of-service (QoS) rules and indicates to the network controller that the second data packet is ready for transmission from the second BD ring.

### BACKGROUND OF THE INVENTION

The present invention relates generally to communication networks, and, more particularly, to a system for managing transmission of data packets in a communication network.

A communication network typically includes multiple digital systems including gateways, switches, access points and base stations, which exchange data packets. The digital systems include system-on-chips (SoCs) that manage data transmission across multiple digital systems. Each data packet is assigned a priority based on its content. For example, a video data packet may have a higher priority than low priority data packets (e.g., non-delay sensitive data packets used for Internet access) as delay in the processing or transmission of the video data packets degrades the user experience. Likewise, Voice-over-Internet Protocol (VoIP) data packets may be marked with a high priority to ensure a high quality voice call without any time delays.

The digital systems implement quality-of-service (QoS) to ensure a priority-based transmission of data packets in which high priority data packets are processed and transmitted earlier than the low priority data packets. QoS refers to a set of standards and mechanisms that the digital system uses to mark priority for the data packets and control transmission of the data packets based on available bandwidth. Examples of such standards include priority, classification, shaping and scheduling algorithms which are well known to those of skill in art.

A processor of the SoC may either generate or receive data packets from other SoCs (of other digital systems) in the network, and transmit the data packets to the other SoCs. The SoC has ingress and egress interfaces that receive and transmit data packets, respectively. The data packets are stored in a system memory of the SoC. A network controller of the SoC receives the data packets that are received at the ingress interface and sends the data packets to the processor. Once the data packets are processed by the processor, the network controller controls the transmission of data packets at the egress interface. An example of the network controller is an enhanced triple-speed Ethernet controller (eTSEC). The system memory maintains buffer descriptor rings (also referred to as “transmit queues”) to facilitate the control of the transmission of data packets at the egress interface. Each transmit queue includes multiple buffer descriptors that are associated with the data packets. The buffer descriptors are used as a reference to the data packets stored in the system memory. The ownership of the transmit queues toggles between the processor and the network controller.

When the ownership is with the processor, the processor processes the data packets, places the data packets in the transmit queues by initializing the buffer descriptors with information indicative of the data packets, and sets a ready bit of the buffer descriptors to indicate that the corresponding data packets are ready for transmission. Upon setting the ready bit, the processor transfers the ownership of the transmit queues to the network controller. The network controller de-queues and transmits the data packets in the transmit queues. However, the network controller does not have hardware support to implement QoS so the performance of the digital system may degrade. Hence, the QoS system is implemented in the SoC.

The processor generates multiple virtual queues in the system memory (in addition to the transmit queues) used to implement QoS. Each virtual queue has a specific priority value. Upon creating the virtual queues, the processor runs the priority and classification algorithms on the data packets received from the network controller and places the data packets into the virtual queues based on their priority. During processing of the data packets, the processor executes shaping and scheduling algorithms on the data packets and de-queues the data packets from the virtual queues and en-queues the data packets in the corresponding transmit queues by initializing the buffer descriptors in the transmit queue.

Prior to setting the ready bits of the buffer descriptors in the transmit queue, the processor performs a memory synchronization (referred to as “MSYNC”) check operation to validate whether a set of instructions executed by the processor for initializing the buffer descriptors have been executed properly. Upon completing the MSYNC check operation, the processor sets the ready bit of the buffer descriptor and transfers the ownership of the transmit queue to the network controller. The network controller then de-queues the data packets associated with the buffer descriptors in the transmit queue based on the status of the ready bit.

The aforementioned implementation of QoS requires two levels of queues, viz., virtual and transmit queues. Having two levels of queues and performing the MSYNC check operation increases the time required by the SoC to process and transmit the data packets, which results in fewer data packets being transmitted per unit time and decreases system throughput.

Therefore it would be advantageous to have a system and method for implementing QoS in a communication network that reduces the QoS implementation time, and improves throughput and performance of the communication network.

### BRIEF DESCRIPTION OF THE DRAWINGS

The following detailed description of the preferred embodiments of the present invention will be better understood when read in conjunction with the appended drawings. The present invention is illustrated by way of example, and not limited by the accompanying figures, in which like references indicate similar elements.

FIG. 1 is a schematic block diagram of a system-on-chip (SoC) for transmitting a plurality of data packets in accordance with an embodiment of the present invention;

FIG. 2 is a schematic block diagram illustrating the structures of first and second buffer descriptor rings;

FIG. 3 is a flow chart illustrating a method for en-queuing data packets in accordance with an embodiment of the present invention; and

FIGS. 4A and 4B are a flow chart illustrating a method for de-queuing data packets in accordance with an embodiment of the present invention.

### DETAILED DESCRIPTION OF THE INVENTION

The detailed description of the appended drawings is intended as a description of the currently preferred embodiments of the present invention, and is not intended to represent the only form in which the present invention may be practiced. It is to be understood that the same or equivalent functions may be accomplished by different embodiments that are intended to be encompassed within the spirit and scope of the present invention.

In an embodiment of the present invention, a system for transmitting a plurality of data packets is provided. The system comprises a data buffer, a memory, a packet en-queuing module and a packet de-queuing module. The data buffer stores the plurality of data packets. Each data packet has a priority value associated therewith. The memory stores a plurality of buffer descriptor rings. Each buffer descriptor ring has a ring priority value associated therewith. Each buffer descriptor ring includes a plurality of buffer descriptors. The packet en-queuing module that is connected to the data buffer and the memory receives a processing request for a first data packet of the plurality of data packets that has a first priority value associated therewith and identifies a first buffer descriptor ring of the plurality of buffer descriptor rings that has a first ring priority value associated therewith based on the first priority value and a first set of quality-of-service (QoS) rules. The packet en-queuing module then identifies a first buffer descriptor of the first buffer descriptor ring, associates the first buffer descriptor with the first data packet, and en-queues the first data packet for transmission. The packet de-queuing module that is connected to the data buffer and the memory identifies a second buffer descriptor ring of the plurality of buffer descriptor rings that has a second ring priority value associated therewith based on a second set of QoS rules. The packet de-queuing module then identifies a second buffer descriptor of the second buffer descriptor ring that is associated with a second data packet of the plurality of data packets, and de-queues the second data packet for transmission based on the second set of QoS rules.

In another embodiment of the present invention, a method for transmitting a plurality of data packets in a system that includes a data buffer and a memory is provided. The data buffer stores the plurality of data packets. Each data packet has a priority value associated therewith. The memory stores a plurality of buffer descriptor rings. Each buffer descriptor ring has a ring priority value associated therewith. Each buffer descriptor ring includes a plurality of buffer descriptors. The method includes receiving a processing request for a first data packet of a plurality of data packets that has a first priority value associated therewith. A first buffer descriptor ring of the plurality of buffer descriptor rings that has a first ring priority value associated therewith is identified based on the first priority value and a first set of QoS rules. A first buffer descriptor of the first buffer descriptor ring is identified. The first buffer descriptor is then associated with the first data packet and the first data packet is en-queued for transmission. A second buffer descriptor ring of the plurality of buffer descriptor rings that has a second ring priority value associated therewith is identified based on a second set of QoS rules. A second buffer descriptor of the second buffer descriptor ring that is associated with a second data packet of the plurality of data packets is then identified. The second data packet is de-queued for transmission based on the second set of QoS rules.

In yet another embodiment of the present invention, a system for transmitting a plurality of data packets is provided. The system comprises a data buffer, a memory, a packet en-queuing module, a packet de-queuing module and a network controller. The data buffer stores the plurality of data packets. Each data packet has a priority value associated therewith. The memory stores a plurality of buffer descriptor rings. Each buffer descriptor ring has a ring priority value associated therewith. Each buffer descriptor ring includes a plurality of buffer descriptors. The packet en-queuing module that is connected to the data buffer and the memory stores a first set of QoS rules. The packet en-queuing module receives a processing request for a first data packet of the plurality of data packets that has a first priority value associated therewith and identifies a first buffer descriptor ring of the plurality of buffer descriptor rings that has a first ring priority value associated therewith based on the first priority value and a first set of QoS rules. The packet en-queuing module then identifies a first buffer descriptor of the first buffer descriptor ring, associates the first buffer descriptor with the first data packet, and en-queues the first data packet for transmission. The packet de-queuing module that is connected to the data buffer and the memory stores a second set of QoS rules. The packet de-queuing module identifies a second buffer descriptor ring of the plurality of buffer descriptor rings that has a second ring priority value associated therewith based on a second set of QoS rules. The packet de-queuing module then identifies a second buffer descriptor of the second buffer descriptor ring that is associated with a second data packet of the plurality of data packets, and de-queues the second data packet for transmission based on the second set of QoS rules. The network controller that is connected to the data buffer, the memory and the en-queuing and de-queuing modules, transmits the second data packet.

Various embodiments of the present invention provide a system for transmitting a plurality of data packets in a communication network. The system includes a data buffer, a memory, packet en-queuing and de-queuing modules, and a network controller. The data buffer stores the plurality of data packets. Each data packet has a priority value associated therewith. The memory stores a plurality of buffer descriptor rings of which each buffer descriptor ring is a transmit queue and has a ring priority value associated therewith. Each transmit queue includes a plurality of buffer descriptors. The network controller uses the plurality of transmit queues for transmitting the plurality of data packets. The packet en-queuing module receives a processing request for a first data packet of the plurality of data packets that has a first priority value associated therewith and identifies a first transmit queue of the plurality of transmit queues that has a first ring priority value associated therewith based on the first priority value and a first set of QoS rules. The packet en-queuing module then identifies a first buffer descriptor of the first transmit queue, associates the first buffer descriptor with the first data packet, and en-queues the first data packet in the first transmit queue. The packet de-queuing module identifies a second transmit queue of the plurality of transmit queues that has a second ring priority value associated therewith based on a second set of QoS rules. The packet de-queuing module then identifies a second buffer descriptor of the second transmit queue that is associated with a second data packet of the plurality of data packets, and de-queues the second data packet from the second transmit queue for transmission based on the second set of QoS rules. The packet en-queuing and de-queuing modules implement the first and second sets of QoS rules using a single level of transmit queues. The time required by the packet en-queuing and de-queuing modules to implement the first and second sets of QoS rules is sufficient for executing the set of instructions required for initializing the buffer descriptors of the transmit queues, thus eliminating the need of performing the conventional MSYNC check operation. Since the technique uses a single level of transmit queues and eliminates the need of the MSYNC check operation, the QoS implementation time is reduced, thereby improving the throughput of the SoC and improving the performance of the communication network.

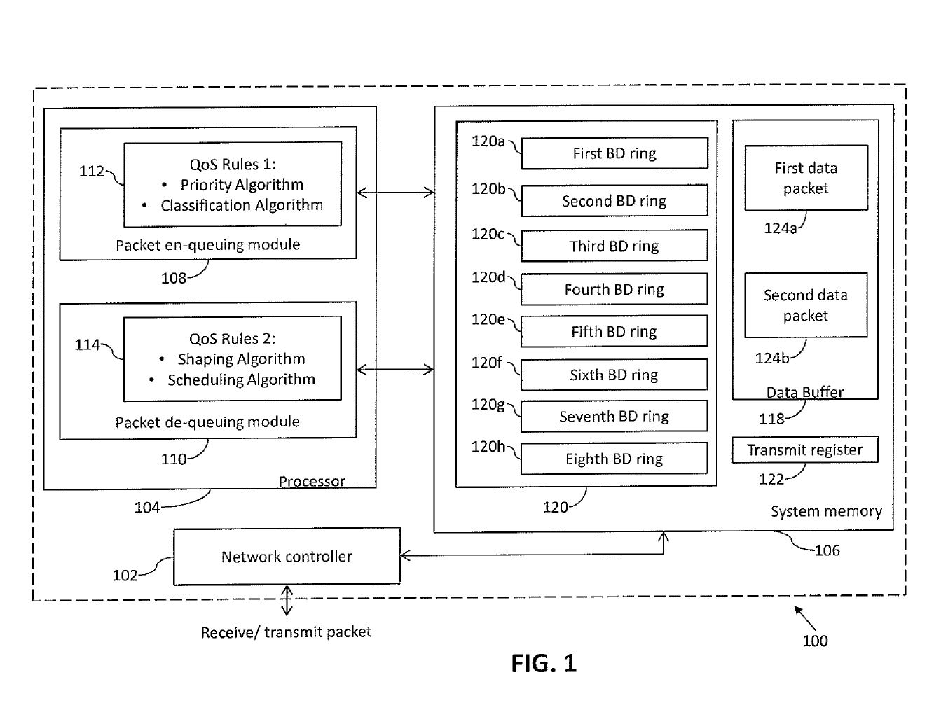

Referring now to FIG. 1, a schematic block diagram of a system-on-chip (SoC) 100 in accordance with an embodiment of the present invention is shown. The SoC 100 is integrated in a digital system that is a part of a communication network (not shown) and manages data transmission across multiple such digital systems of the communication network. The SoC 100 includes a network controller 102, a processor 104 and a system memory 106. The processor 104 includes packet en-queuing and de-queuing modules 108 and 110. The packet en-queuing module 108 stores a first set of QoS rules 112 and the packet de-queuing module 110 stores a second set of QoS rules 114. The first set of QoS rules 112 includes priority and classification algorithms and the second set of QoS rules 114 includes shaping and scheduling algorithms.

The system memory 106 is connected to the processor 104 and includes a data buffer 118, a plurality of buffer descriptor (BD) rings 120 and a transmit register 122. The data buffer 118 stores a plurality of data packets 124 including first and second data packets 124a and 124b. Each data packet 124 has a priority value associated therewith. The BD rings 120 include first through eighth BD rings 120a-120h. Each BD ring 120 has a ring priority value associated therewith. The network controller 102 is connected to the system memory 106. The network controller 102 receives the data packets 124 from the digital systems of the communication network and stores the data packets 124 in the system memory 106. The network controller 102 uses the BD rings 120 for transmission of the data packets 124 to the digital systems of the communication network. Thus, the BD rings 120 are also referred to as transmission queues.

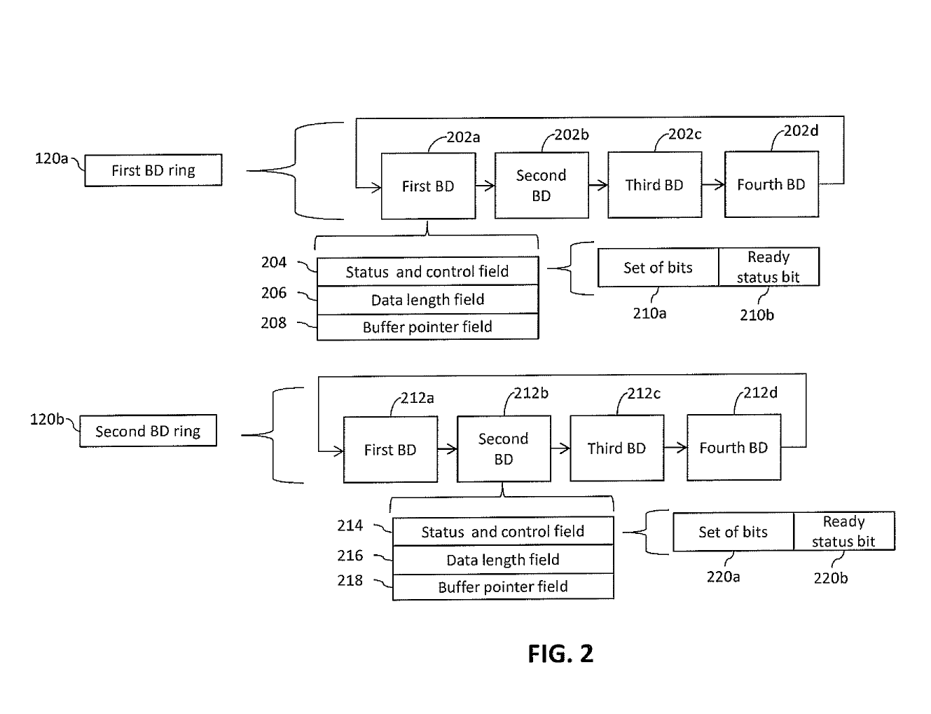

Referring now to FIG. 2, a schematic block diagram illustrating the structure of the BD rings 120 is shown. The first BD ring 120a includes a plurality of BDs 202 including first through fourth BDs 202a-202d (hereinafter referred to as a BD 202). Each BD 202 includes a status and control field 204, a data length field 206 and a buffer pointer field 208. The status and control field 204 stores a set of bits 210a and a ready status bit 210b. The second BD ring 120b includes a plurality of BDs 212 including first through fourth BDs 212a-212d (hereinafter referred to as a BD 212). Each BD 212 includes a status and control field 214, a data length field 216 and a buffer pointer field 218. The status and control field 214 stores a set of bits 220a and a ready status bit 220b. The BDs 202 are similar to the BDs 212.

The processor 104 generates a processing request for each data packet 124 received by the network controller 102 from a communication network (not shown). The processing request may also be generated when the processor 104 generates the data packet 124 that is to be transmitted by the SoC 100 to the communication network. The processing request indicates that the data packets 124 are stored in the data buffer 118 and are ready for processing and transmission to the communication network. In an example, the packet en-queuing module 108 receives the processing request for the first data packet 124a.

The priority value associated with the first data packet 124a (hereinafter referred to as “first priority value”) varies based on the priority level of the first data packet 124a. The packet en-queuing module 108 compares the first priority value with the ring priority values corresponding to the first through eighth BD rings 120a-120h by using the first set of QoS rules 112 and selects a BD ring 120 whose ring priority value matches the first priority value. In an example, the packet en-queuing module 108 selects the first BD ring 120a that has a first ring priority value associated therewith which corresponds to the first priority value of the data packet 124a.

Thereafter the packet en-queuing module 108 polls the first through fourth BDs 202 and identifies the first BD 202a that is free. The packet en-queuing module 108 associates the first BD 202a with the first data packet 124a and en-queues the first data packet 124a in the first BD ring 120a. The packet en-queuing module 108 associates the first BD 202a with the first data packet 124a by initializing the buffer pointer field 208 of the first BD 202a with an address of the first data packet 124a and by setting the set of bits 210a stored in the status and control field 204 of the first BD 202a with information indicative of the first BD 202a. The information indicative of the first BD 202a may include information indicating whether the BD 202a is free and whether the BD 202a is the last BD of the BD ring 120a.

Upon en-queuing the first data packet 124a in the first BD ring 120a, the packet en-queuing module 108 marks the BD 202a to be busy and schedules a de-queue task. If the ring priority values of the BD rings 120 do not match the first priority value, the packet en-queuing module 108 fails to identify the first BD ring 120a and drops the first data packet 124a and continues to look for incoming processing requests associated with the data packets 124. Similarly, the packet en-queuing module 108 en-queues other data packets 124 received subsequent to the first data packet 124a in to BD rings 120.

The data packets 124 that are en-queued in the BD rings 120 are referred to as en-queued data packets 124. The packet de-queuing module 110 receives an indication when the de-queue task is scheduled by the packet en-queuing module 108. Each de-queue task is associated with a transmission budget. The transmission budget determines the number of BDs that can be de-queued by the packet de-queuing module 110 for a single de-queue task. The packet de-queuing module 110 determines a desired ring priority value based on the second set of QoS rules 114. The packet de-queuing module 110 compares the desired ring priority value with the ring priority values corresponding to the first through eighth BD rings 120a-120h and selects a BD ring 120 whose ring priority value matches the desired ring priority value. In an example, the packet de-queuing module 110 identifies the second BD ring 120b based on a second ring priority value associated therewith.

If the second BD ring 120b is successfully identified, the packet de-queuing module 110 searches for a BD 212 (which is not free) in the second BD ring 120b and identifies the second BD 212b associated with the second data packet 124b. The second data packet 124b is en-queued in the second BD ring 120b by the packet en-queuing module 108. If the second BD 212b is successfully identified, the packet de-queuing module 110 determines whether the second data packet 124b is eligible for transmission based on the second set of QoS rules 114. If the second data packet 124b is eligible for transmission, the packet de-queuing module 110 de-queues the second data packet 124b by setting the ready status bit 220b stored in the status and control field 214 and the data length field 216 of the second BD 212b. Setting the ready status bit 220b indicates that the second data packet 124b is ready for transmission. Thus, the packet de-queuing module 110 controls the transmission of the second data packet 124b by determining when to set the ready status bit 220b.

The packet de-queuing module 110 then updates the transmit register 122 to send an indication to the network controller 102 that the second data packet 124b is ready for transmission to the communication network. If the transmission budget is not hit, the packet de-queuing module 110 proceeds to identify a subsequent BD 212 (which is not free) in the second BD ring 120b. In an embodiment, if there is no BD 212 (which is not free) in the second BD ring 120b, the packet de-queuing module 110 fails to look for another BD ring 120 having a with lower ring priority value.

In another embodiment, if the packet de-queuing module 110 determines that the second data packet 124b is in-eligible for transmission based on the second set of QoS rules 114, the packet de-queuing module 110 proceeds to look for another BD ring 120 with lower ring priority value. If the packet de-queuing module 110 determines that the second BD ring 120b has the lowest ring priority value, the packet de-queuing module 110 stops searching for another BD ring 120 with a lower ring priority value as the packet de-queuing module 110 has reached the last BD ring 120.

The network controller 102 receives the indication that the second data packet 124b is ready for transmission when the packet de-queuing module 110 updates the transmit register 122. The network controller 102 transmits the second data packet 124b from the data buffer 118 based on the ready status bit 220b stored in the status and control field 214 of the second BD 212b. Thus, the en-queued data packets 124 are transmitted when the packet de-queuing module 110 sets the ready status bit 220b stored in the status and control field 214 of the BDs 212 associated with the en-queued data packets 124. The network controller 102 clears the set of bits 220a and the ready status bit 220b stored in the status and control field 214, the data length field 216, and the buffer pointer field 218 of the second BD 212b after the second data packet 124b is transmitted. In an embodiment of the present invention, the network controller 102 is an enhanced triple-speed Ethernet controller (eTSEC).

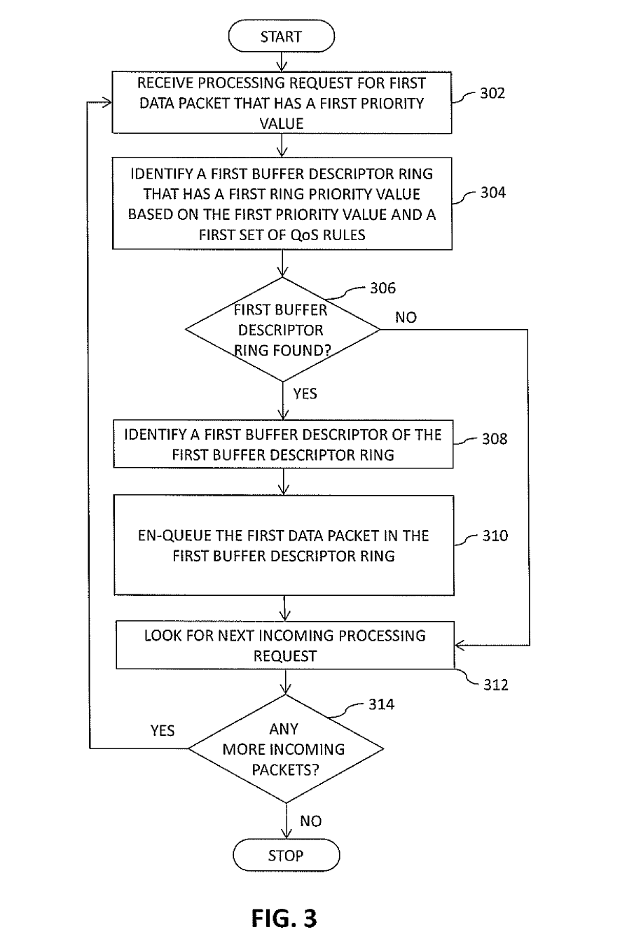

Referring now to FIG. 3, a flow chart illustrating a method for en-queuing data packets in accordance with an embodiment of the present invention is shown. At step 302, the packet en-queuing module 108 receives the processing request for the first data packet 124a having the first priority value therewith. At step 304, the packet en-queuing module 108 compares the first priority value with the ring priority values corresponding to the first through eighth BD rings 120a-120h by using the first set of QoS rules 112 and selects the first BD ring 120a having the first ring priority value associated therewith. At step 306, the packet en-queuing module 108 checks to determine whether the first BD ring 120a is identified. If the packet en-queuing module 108 determines that the first BD ring 120a is identified at step 306, step 308 is executed.

At step 308, the packet en-queuing module 108 polls the first through fourth BDs 202 and identifies the first BD 202a as to be free. At step 310, the packet en-queuing module 108 associates the first BD 202a by initializing the buffer pointer field 208 of the first BD 202a with an address of the first data packet 124a and by setting the set of bits 210a stored in the status and control field 204 of the first BD 202a with information indicative of the first BD 202a for en-queuing the first data packet 124a in the first BD ring 120a and schedules the de-queue task. At step 312, the packet en-queuing module 108 looks for incoming processing requests associated with data packets 124.

However, if at step 306, the packet en-queuing module 108 fails to identify the first BD ring 120a as the ring priority values of the BD rings 120 do not match the first priority value, step 312 is executed. At step 314, packet en-queuing module 108 checks for data packets 124 represented by incoming processing requests. If it is determined that there is an incoming processing request at step 314, steps 302-312 are repeated.

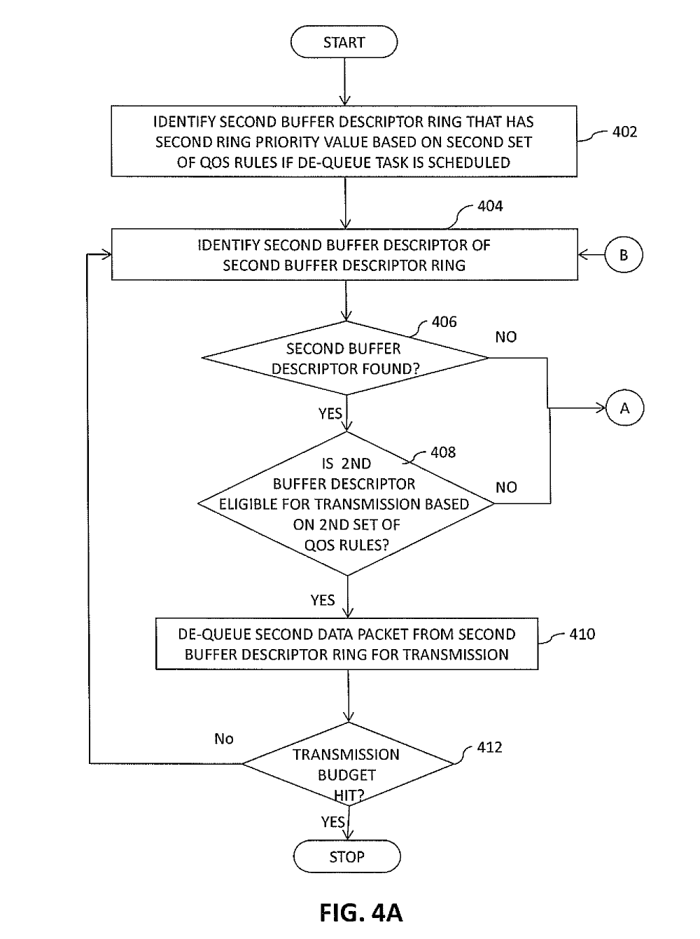

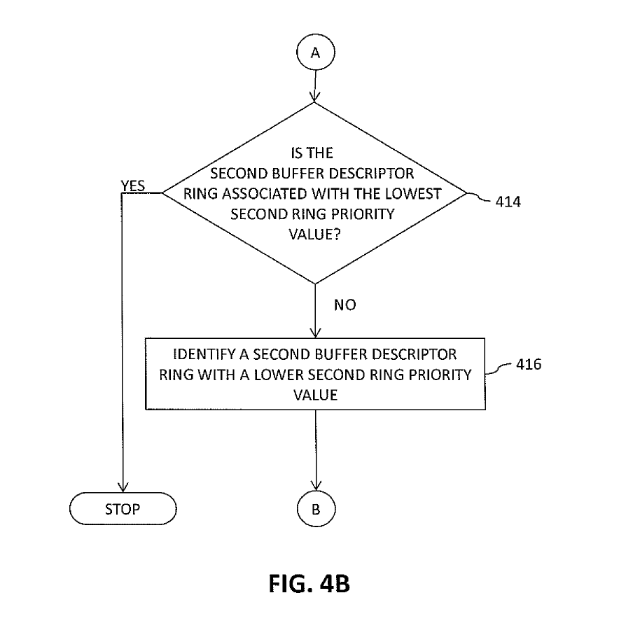

Referring now to FIGS. 4A and 4B, a flow chart illustrating a method for de-queuing data packets in accordance with an embodiment of the present invention are shown. At step 402, the packet de-queuing module 110 receives an indication when the de-queue task is scheduled by the packet en-queuing module 108 and identifies the second BD ring 120b that has the second ring priority value associated therewith based on second set of QoS rules 114. At step 404, the packet de-queuing module 110 searches for a BD 212 (which is not free) in the second BD ring 120b and identifies the second BD 212b associated with the second data packet 124b.

At step 406, the packet de-queuing module 110 checks to determine if the second BD 212b is identified. If the packet de-queuing module 110 determines that the second BD 212b is identified at step 406, step 408 is executed. At step 408, the packet de-queuing module 110 checks to determine whether the second data packet 124b is eligible for transmission based on the second set of QoS rules 114. If the packet de-queuing module 110 determines that the second data packet 124b is eligible for transmission at step 408, step 410 is executed. At step 410, the packet de-queuing module 110 de-queues the second data packet 124b from the second BD ring 120b for transmission by setting the ready status bit 220b stored in the status and control field 214 and the data length field 216 of the second BD 212b.

At step 412, the packet de-queuing module 110 determines whether the transmission budget has been hit. If the packet de-queuing module 110 determines that the transmission budget is not hit at step 412, steps 404-410 are repeated. If at step 406, the packet de-queuing module 110 fails to identify the second BD 212b as there is no BD 212 (which is not free) in the second BD ring 120b, step 414 is executed. If at step 408, the packet de-queuing module 110 determines that the second data packet 124b is in-eligible for transmission, step 414 is executed. At step 414, packet de-queuing module 110 checks whether the second BD ring 120b is associated with the lowest second ring priority value to determine whether the packet de-queuing module 110 has reached the last BD ring 120. If the packet de-queuing module 110 determines that the second BD ring 120b is not associated with the lowest second ring priority value at step 414, step 416 is executed. At step 416, packet de-queuing module 110 identifies another second BD ring with a lower second ring priority value.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

1. A system for transmitting a plurality of data packets, comprising:
a data buffer for storing the plurality of data packets, wherein each data packet has an associated priority value;
a memory for storing a plurality of buffer descriptor rings, wherein each buffer descriptor ring has a ring priority value, and each buffer descriptor ring includes a plurality of buffer descriptors;
a packet en-queuing module, connected to the data buffer and the memory, that receives a processing request for a first data packet of the plurality of data packets that has a first priority value associated therewith, identifies a first buffer descriptor ring of the plurality of buffer descriptor rings that has a first ring priority value associated therewith, based on the first priority value and a first set of quality-of-service (QoS) rules, identifies a first buffer descriptor of the first buffer descriptor ring, associates the first buffer descriptor with the first data packet, and en-queues the first data packet for transmission; and
a packet de-queuing module, connected to the data buffer and the memory, that identifies a second buffer descriptor ring of the plurality of buffer descriptor rings that has a second ring priority value associated therewith, based on a second set of QoS rules, identifies a second buffer descriptor of the second buffer descriptor ring that is associated with a second data packet of the plurality of data packets, and de-queues the second data packet for transmission based on the second set of QoS rules.

2. The system of claim 1, wherein the packet en-queuing module stores the first set of QoS rules and the packet de-queuing module stores the second set of QoS rules.

3. The system of claim 1, wherein the first set of QoS rules comprises a priority and classification algorithm and the second set of QoS rules comprises a shaping and scheduling algorithm.

4. The system of claim 1, wherein each buffer descriptor includes a buffer pointer field that holds an address of a data packet associated therewith, a status and control field that includes a ready status bit that indicates an eligibility of transmission of the data packet, and a data length field that indicates a size of the data packet.

5. The system of claim 4, wherein the packet en-queuing module associates the first buffer descriptor with the first data packet by setting the buffer pointer field of the first buffer descriptor with an address of the first data packet.

6. The system of claim 4, wherein the packet de-queuing module de-queues the second data packet by setting the data length field with a size of the second data packet and a ready status bit of a status and control field of the second buffer descriptor indicating eligibility of transmission of the second data packet.

7. The system of claim 6, further comprising a network controller, connected to the data buffer, the memory, and the en-queuing and de-queuing modules, that transmits the second data packet based on a value of the ready status bit of the status and control field of the second buffer descriptor.

8. The system of claim 7, where the network controller comprises an Ethernet controller.

9. The system of claim 1, wherein the first buffer descriptor is a free buffer descriptor.

10. The system of claim 1, wherein the second ring priority value is the highest ring priority value of the plurality of ring priority values.

11. A method for transmitting a plurality of data packets in a system that includes a data buffer that stores the plurality of data packets, wherein each data packet has an associated priority value, and a memory that stores a plurality of buffer descriptor rings, wherein each buffer descriptor ring has a ring priority value, and wherein each buffer descriptor ring includes a plurality of buffer descriptors, the method comprising:
receiving a processing request for a first data packet of a plurality of data packets that has a first priority value;
identifying a first buffer descriptor ring of the plurality of buffer descriptor rings that has a first ring priority value, based on the first priority value and a first set of quality-of-service (QoS) rules;
identifying a first buffer descriptor of the first buffer descriptor ring;
associating the first buffer descriptor with the first data packet;
en-queuing the first data packet for transmission;
identifying a second buffer descriptor ring of the plurality of buffer descriptor rings, that has a second ring priority value, based on a second set of QoS rules;
identifying a second buffer descriptor of the second buffer descriptor ring that is associated with a second data packet of the plurality of data packets; and
de-queuing the second data packet for transmission based on the second set of QoS rules.

12. The method of claim 11, wherein the first set of QoS rules comprises a priority and classification algorithm and the second set of QoS rules comprises a shaping and scheduling algorithm.

13. The method of claim 11, wherein each buffer descriptor includes a buffer pointer field that indicates an address of a data packet associated therewith, a status and control field that includes a ready status bit that indicates an eligibility of transmission of the data packet, and a data length field that indicates a size of the data packet.

14. The method of claim 13, wherein associating the first buffer descriptor with the first data packet comprises setting a buffer pointer field of the first buffer descriptor with an address of the first data packet.

15. The method of claim 13, wherein de-queuing the second data packet comprises setting a data length field with a size of the second data packet and a ready status bit of a status and control field of the second buffer descriptor indicating eligibility of transmission of the second data packet.

16. The method of claim 15, further comprising transmitting the second data packet when the ready status bit of the status and control field of the second buffer descriptor is set.

17. The method of claim 11, wherein the first buffer descriptor is a free buffer descriptor.

18. The method of claim 11, wherein the second ring priority value is the highest ring priority value of the plurality of ring priority values.

19. A system for transmitting a plurality of data packets, comprising:
a data buffer that stores the plurality of data packets, wherein each data packet has an associated priority value;
a memory that stores a plurality of buffer descriptor rings, wherein each buffer descriptor ring has an associated ring priority value, and wherein each buffer descriptor ring includes a plurality of buffer descriptors;
a packet en-queuing module, connected to the data buffer and the memory, that stores a first set of quality-of-service (QoS) rules, receives a processing request for a first data packet of the plurality of data packets that has a first priority value associated therewith, identifies a first buffer descriptor ring of the plurality of buffer descriptor rings that has a first ring priority value, based on the first priority value and the first set of QoS rules, identifies a first buffer descriptor of the first buffer descriptor ring, associates the first buffer descriptor with the first data packet, and en-queues the first data packet for transmission;
a packet de-queuing module, connected to the data buffer and the memory, that stores a second set of QoS rules that identifies a second buffer descriptor ring of the plurality of buffer descriptor rings that has a second ring priority value associated therewith, based on the second set of QoS rules, identifies a second buffer descriptor of the second buffer descriptor ring, that is associated with a second data packet of the plurality of data packets, and de-queues the second data packet for transmission based on the second set of QoS rules; and
a network controller, connected to the data buffer, the memory and the en-queuing and de-queuing modules, that transmits the second data packet.

20. The system of claim 19, wherein the first set of QoS rules comprises a priority and classification algorithm and the second set of QoS rules comprises a shaping and scheduling algorithm.
